(19) United States
(12) Patent Application Publication
(10) Pub. No.: US 2004/0220994 A1
(43) Pub. Date: Nov. 4, 2004

(54) Low power adder circuit utilizing both static and dynamic logic

(75) Inventors: Sanu K. Mathew, Hillsboro, OR (US); Mark A. Anders, Hillsboro, OR (US); Ram Krishnamurthy, Portland, OR (US)

Correspondence Address: FLESHNER & KIM, LLP, P.O. Box 221200, Chantilly, VA, 20153-1200, US

(73) Assignee: Intel Corporation

(21) Appl. No.: 10/426,044

(22) Filed: Apr. 30, 2003

(51) Int. Cl. G06F 7/50

(52) U.S. Cl. 708/670

(57) ABSTRACT

Embodiments of the present invention generally relate to logic circuitry that implements both static logic and dynamic logic. In embodiments, static logic is implemented for functions which are non-performance critical and dynamic logic is implemented for functions that are performance critical. Accordingly, power savings can be realized.

### BACKGROUND OF THE INVENTION

1. Field of the Invention

The field of the invention generally relates to electronics.

2. Background of the Related Art

Electronics are very important in the lives of many people. In fact, electronics are present in almost all electrical devices (e.g. radios, televisions, toasters, and computers). Many times electronics are virtually invisible to a user because they can be made up of very small devices inside a case. Although electronics may not be readily visible, they can be very complicated. It may be desirable in many electrical devices for the electronics to become smaller and/or consume less power. Smaller devices may be more portable and convenient to use by a user. Devices that consume less power may allow a battery power supply to have a longer useful life. Also, devices that consume less power may also generate less heat during operation. The generation of heat by electronics may adversely affect the maximum efficiency of an electronic device.

### BRIEF DESCRIPTION OF THE DRAWINGS

FIG. 1 is an exemplary global diagram of a portion of a computer.

FIG. 2 is an exemplary diagram illustrating dynamic logic and static logic interfacing at an interface circuit.

FIG. 3 is an exemplary block diagram of a static logic device which includes a plurality of adders.

FIG. 4 is an example of a dynamic logic device that generates carries for segmented adders.

FIG. 5 is an exemplary circuit that interfaces static logic and dynamic logic to output a sum of a first number and a second number.

FIGS. 6-8 are illustrations of exemplary embodiments of the present invention.

### DETAILED DESCRIPTION OF PREFERRED EMBODIMENTS

Electrical hardware (e.g. a computer) may include many electrical devices. In fact, a computer may include millions of electrical devices (e.g. transistors, resistors, and capacitors). These electrical devices must work together in order for hardware to operate correctly. Accordingly, electrical devices of hardware may be electrically coupled together. This coupling may be either direct coupling (e.g. direct electrical connection) or indirect coupling (e.g. electrical communication through a series of components).

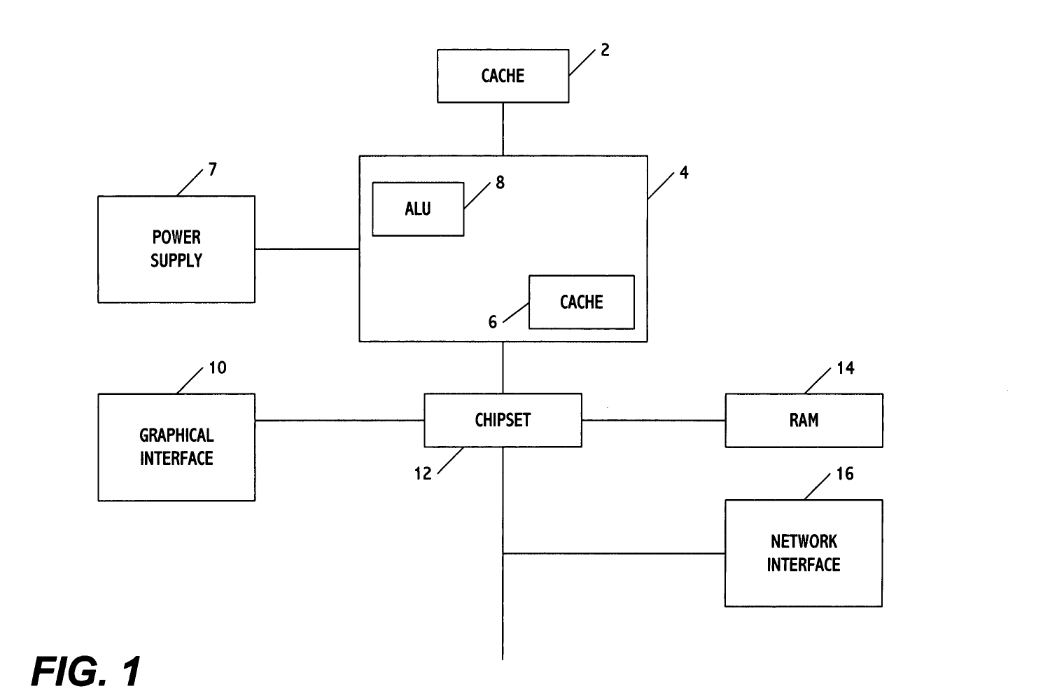

FIG. 1 is an exemplary global illustration of a computer. The computer may include a processor 4, which acts as a brain of the computer. Processor 4 may be formed on a die. Processor 4 may include an Arithmetic Logic Unit (ALU) 8 and may be included on the same die as processor 4. ALU 8 may be able to perform continuous calculations in order for processor 4 to operate. Processor 4 may include cache memory 6 which may be for temporarily storing information. Cache memory 6 may be included on the same die as processor 4. The information stored in cache memory 6 may be readily available to ALU 8 for performing calculations. A computer may also include external cache memory 2 to supplement internal cache memory 6. Power supply 7 may be provided to supply energy to processor 4 and other components of a computer. A computer may include chip set 12 coupled to processor 4. Chip set 12 may intermediately couple processor 4 to other components of a computer (e.g. graphical interface 10, Random Access Memory (RAM) 14, and/or a network interface 16). One exemplary purpose of chip set 12 is to manage communication between processor 4 and these other components. For example, graphical interface 10, RAM 14, and/or network interface 16 may be coupled to chip set 12.

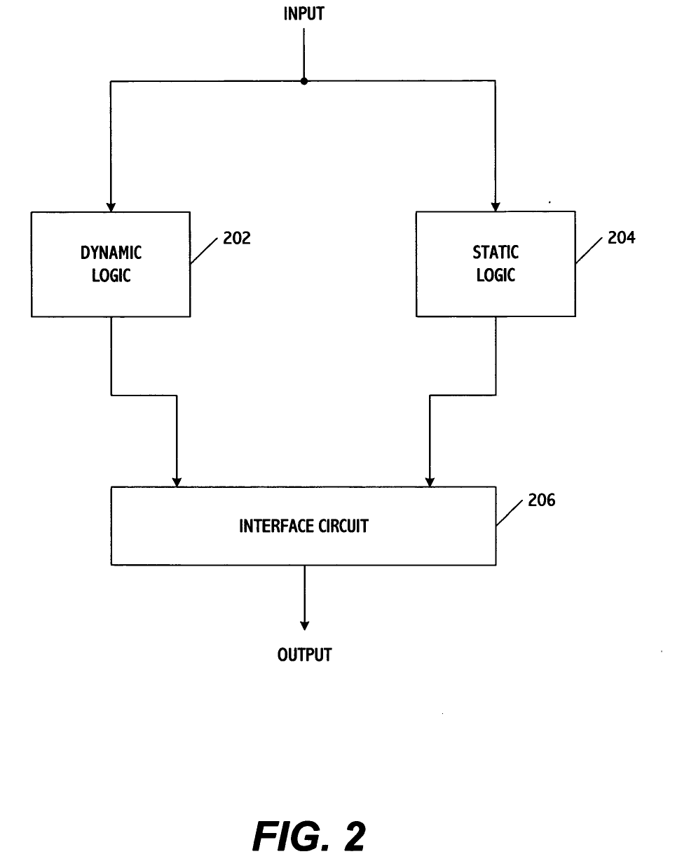

FIG. 2 is an exemplary block diagram illustrating dynamic logic circuit 202 and static logic circuit 204 interfacing at interface circuit 206. In exemplary embodiments, inputs to dynamic logic circuit 202 and static logic 204 are the same. In some embodiments, the inputs to dynamic logic circuit 202 and static logic circuit 204 may include multiple wire lines. Dynamic logic circuit 202 may have an output electrically coupled to an input of interface circuit 206. Likewise, static logic circuit 204 may have an output that is electrically coupled to an input of interface circuit 206.

In embodiments of the present invention, dynamic logic circuit 202 and static logic circuit 204 process the same data in parallel. Interface circuit 206 may receive output data from dynamic logic circuit 202 and output data from static logic circuit 204, processes the received data, and output a result. Because dynamic logic circuit 202 has a different circuit structure than static logic circuit 204, interface circuit 206 may interface dynamic logic and static logic.

There are tradeoffs between dynamic logic circuits and static logic circuits. For instance, in dynamic logic circuits a series of logic functions can be performed relatively quickly. This quickness may be attributed to a clock signal precharging a dynamic logic circuit every clock cycle. Static logic circuits may operate slower than dynamic logic circuits, due to the presence of both pull-up and pull-down logic blocks, which result in larger gate and diffusion capacitance. In contrast, dynamic circuits only require a pull-down logic block since the clock precharges the output every clock cycle. However, static logic circuits may consume less power than dynamic logic circuits. This power consumption relationship may be attributed to the circumstance that states of components in a static logic circuit only change when the inputs change. However, in dynamic logic circuits the states of the transistors and components changes in each clock cycle (or logic operation). Also, in dynamic logic circuits, the output node is precharged every clock cycle and then discharged. In general, the tradeoff between static logic circuits and dynamic logic circuits is speed and power consumption.

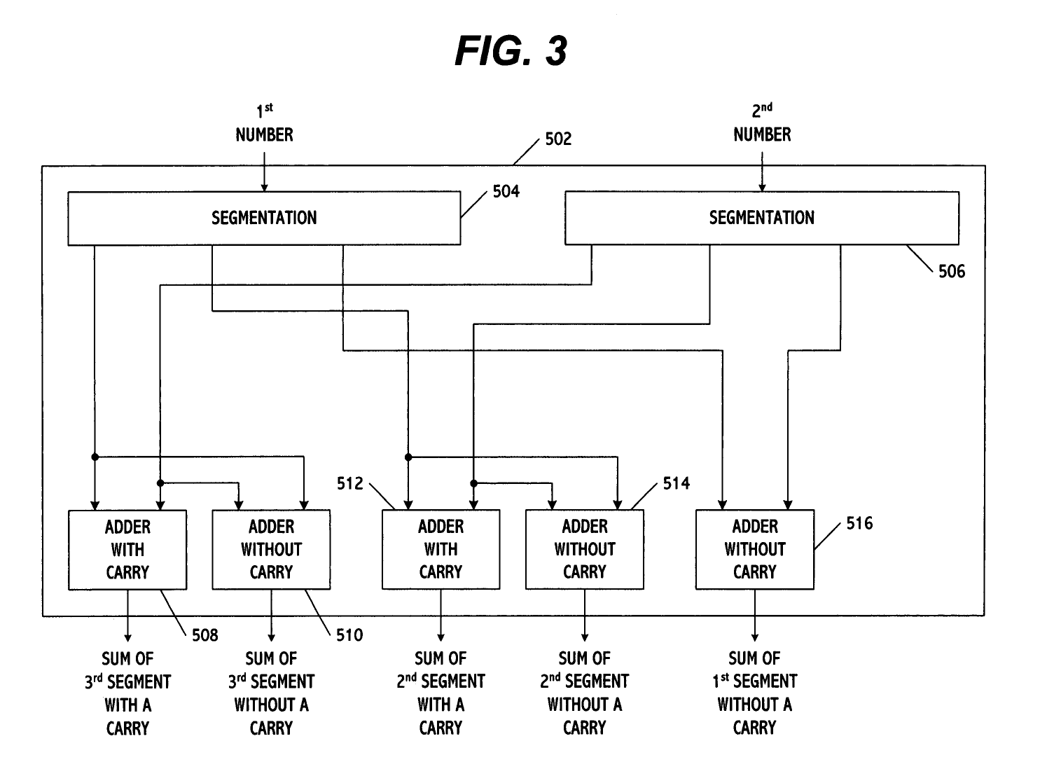

FIG. 3 is an exemplary illustration of static logic circuit 502 including a plurality of adders 508, 510, 512, 514, and 516. In embodiments, circuit 502 may relate to the static logic circuit 204 illustrated in FIG. 2. In other words, static logic circuit 502 may operate in parallel with a dynamic logic circuit. Further, static logic circuit 502 may receive the same input as a dynamic logic circuit.

Circuit 502 may receive a first number and a second number. Both the first number and the second number may be segmented into a plurality of segments. For the purposes of example and simplification, the circuit in FIG. 3 divides both the first number and the second number into three segments. Segmentation 504 and 506 may be a simplification of a plurality of parallel wire lines which are segmented and rerouted throughout the circuit. One of ordinary skill in the art would appreciate that the first number and the second number may be segmented any number of times.

Adder 516 is an adder without a carry. The output of adder 516 is a sum of the first segment of both the first number and the second number without considering a carry from a lower-order adjacent segment. For example, if both the first number and the second number are twelve digit numbers, they may be divided into three segments, each having four digits. Adder 516 may add the first four digits of the first number and the first four digits of the second number by adding the first segment of the first number and the first segment of the second number.

Adders 512 and 514 both add a second segment of the first number and a second segment of the second number. For example, if the first number and the second number are both twelve digit numbers and each segment is four digits, both adders 512 and 514 will add the second four digits of each number. Adder 514 adds the second segment of the first and second number, assuming that there will not be a carry generated from addition of the highest order digit of the first segment. Likewise, adder 512 will output the sum of the second segment of the first number and the second number assuming that there will be a carry generated from addition of the highest order digit of the first segment. In other words, adders 512 and 514 compute the same sum of the same segment of the first number and the second number considering both possibilities that there will be a carry generated from addition of the first segment and there will not be a carry generated from addition of the first segment.

Adders 508 and 510 both add a third segment of a first number and a second number. Similar to adder 512, adder 508 adds a third segment of a first number and a third segment of a second number assuming there will be a carry from the addition of the second segment. Similar to adder 514, adder 510 adds the third segment of the first number and the third segment of the second number assuming that there will not be a carry from the addition of the second segment.

This configuration may be beneficial, as the adding of each segment of a first number and a second number is not dependent upon a determination of whether the previous segment generated a carry. Accordingly, the sum of each segment of the first number and the second number can be accomplished in parallel. In other words, there will not be a time lag for the adding of a third segment due to dependency of establishing whether a carry was generated from the adding of the second segment. However, two alternative sums must be computed for the second segment and the third segment.

A determination of whether the sum of the second segment or the sum of the third segment will be affected by a carry generated from a previous adjacent segment is determined in a separate circuit. The separate circuit processes and makes this determination in parallel to the segmented adding accomplished in circuit 502. In other words, the two alternative outputs for the adding of the second segment and the third segment (i.e., output with a carry or output without a carry) are computed and may be subsequently selected based on the output of the separate circuit. Only single adder 516 (without a carry) is necessary for the first segment, as the adding of the first segment may only involve the lowest order digits. Accordingly, it may be assumed, in some embodiments, that a carry will not be generated in a segment having the lowest order digits.

Segments of a first number and a second number may be divided and added in parallel to reduce time lag between the addition of higher order digits and lower order digits of the first number and the second number. Accordingly, a circuit including adders 508, 510, 512, 514, 516 may be implemented in static logic. This may be done to conserve power consumption. One of ordinary skill in the art may appreciate other reasons why static logic may be advantageously implemented in adders 508, 510, 512, 514 and 516.

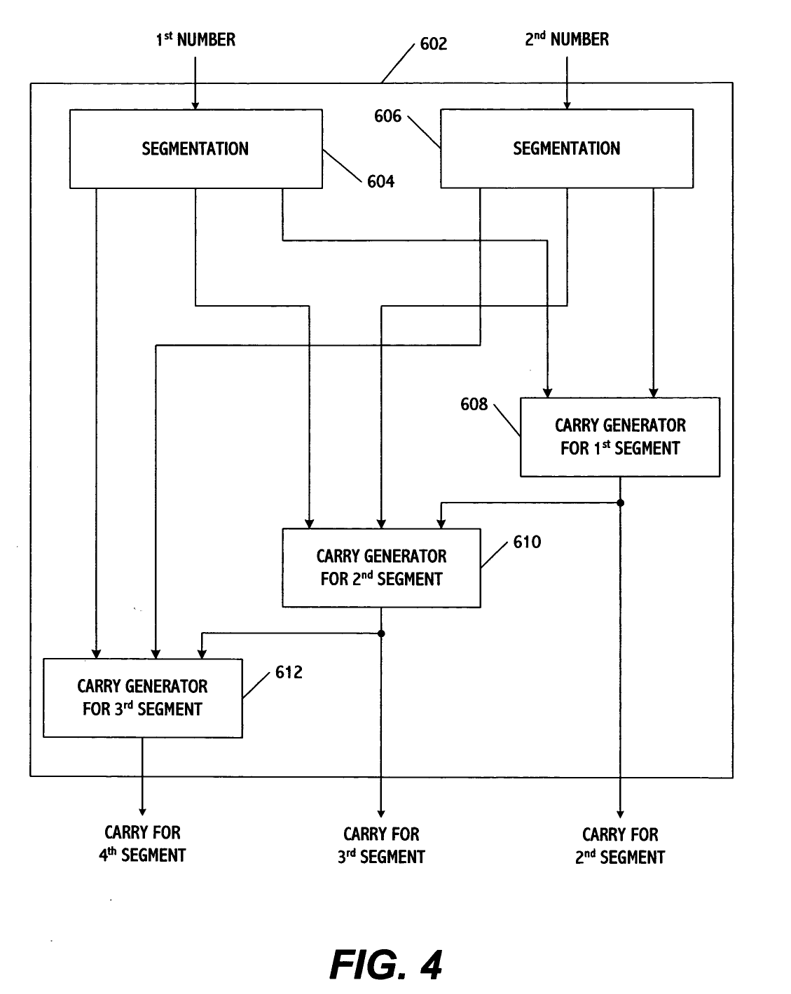

FIG. 4 illustrates dynamic logic circuit 602. Circuit 602 may be, in embodiments, associated with dynamic logic circuit 202 illustrated in FIG. 2. Dynamic logic circuit 602 may operate in parallel to static logic circuit 502. Circuit 602 may receive a first number and a second number as inputs. These inputs may be the same as inputted in parallel to static logic circuit 502. A function of dynamic logic circuit 602 may be to determine whether a carry should be considered in the adding of segments of the first number and the second number. For example, in static logic circuit 502 of FIG. 3, where dual condition outputs are provided for the second segment and the third segment, the determination of dynamic logic circuit 602 may select the ultimate output for each segment.

In FIG. 4, a first number may be segmented in segmentation 604 and a second number may be segmented in segmentation 606. Segmentation 604 and 606 may be a simplification of a plurality of wire lines which are dispersed in segments to various parts of circuit 602. For example, a first segment of wire lines may be segmented at both segmentation 606 and 604 and distributed to carry generator 608. Carry generator 608 may be for determining if a carry is generated from the addition of the first segment The output of carry generator 608 may be used for determining whether a sum of a second segment with a carry or a sum of a second segment without a carry will be applied to the ultimate output. Likewise, carry generator 610 and 612 may be for generating carries produced in the sum of the second segment and the third segment, respectively. Accordingly, the output of carry generator 610 may be for producing a signal that includes an indication of whether the output of adder 508 will be ultimately used or the output of adder 510 will be ultimately used. The output of carry generator 612 may be used for selecting from alternative sums all of a fourth segment (not shown). Although a fourth segment is not illustrated, one of ordinary skill in the art would appreciate that a carry generated for a given segment may be applied to selecting a sum of a subsequent segment or used for an additional digit in the ultimate sum.

The logic circuitry in carry generator 612, 610, and 608 may be dynamic logic. Dynamic logic may be implemented for these carry generators, as computations of determinations of carries in each segment may need to be done relatively fast, so that outputs of static logic circuit 502 can be selected. At least for these reasons, dynamic logic circuits may be implemented for performance-critical operations, while static logic circuits may be implemented for non-performance critical operations.

The determination of whether carries are generated for each segment may consider all of the digits of the first number and the second number. Accordingly, this process may take more time than the computation performed by each of adders 508, 510, 512, 514 and 516 of circuit 502. Accordingly because this function, using dynamic logic, may take more time than the functions of adders 508, 510, 512, 514 and 516, static logic may be implemented for circuit 502 and dynamic logic for circuit 602. Accordingly, by the ability to use static logic for circuit 502, considerable power savings can be afforded as the logic circuits in circuit 502 will consume less power. One of ordinary skill in the art would appreciate that the partition of the segments of the first number and the second number can be optimized for maximum power savings and computation time.

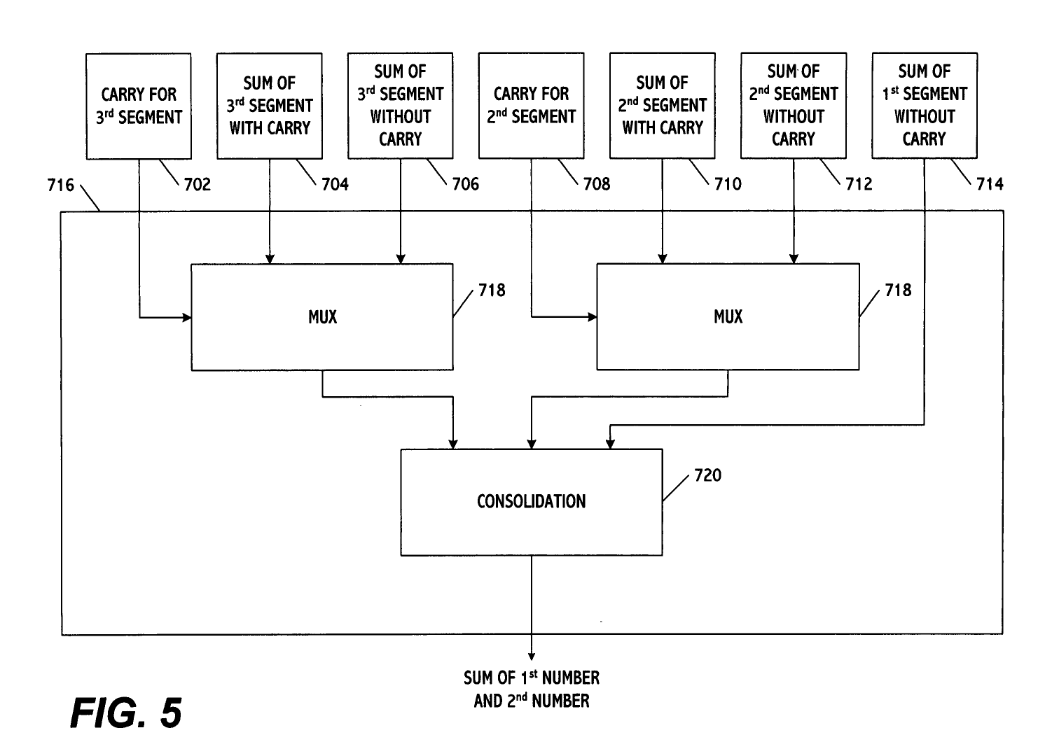

FIG. 5 is an exemplary diagram of an interface circuit that interfaces the outputs of static circuit 502 and dynamic logic circuit 602. As may be recognized, inputs 714, 712, 710, 706, and 704 may be outputs from static logic circuit 502. Likewise, inputs 702 and 708 may be outputs from dynamic logic circuit 602. The sum of the first segment 714 is input into consolidation 720 of interface circuit 716. Consolidation 720 may be wire line routing that outputs the sum of the first number and the second number.

The sum of the second segment without a carry 712 and the sum of the second segment with a carry 710 may be inputted into multiplexer 718. The carry generation determination for the second segment 708 may be input into multiplexer 718 to select between inputs 710 and inputs 712. In other words, if dynamic logic circuit 602 determines that a carry will be applied in the sum of the second segment, then input 708 may select input 710 to be output from MUX 718 and into consolidation 720. Likewise, multiplexer 718 may receive input 704 and 706, which may be selected according to input 702 to be output into consolidation 720. Input 702 may be output from carry generator 610 of dynamic circuit 602 and may be used to select between the output of adder 508 and adder 510 of static logic circuit 502.

The output of consolidation 720 may be the sum of the first number and the second number. The circuits illustrated in FIGS. 3-5 may be advantageous, as several of the processes for adding two numbers may be implemented in parallel. This may consequently reduce the amount of time needed to add two numbers. Additionally, as some of the operations processed in parallel (e.g. the conditional adding of segments of the first number and the second number) take longer than others, the operations that do not contribute to time lag may be implemented in static logic to conserve power. The embodiments illustrated in association with FIGS. 3-5 are merely an example of an implementation of the embodiments illustrated and explained and associated with FIG. 2. In a general embodiment of the present invention, static logic circuits and dynamic logic circuits can be used together for a reduction in power consumption.

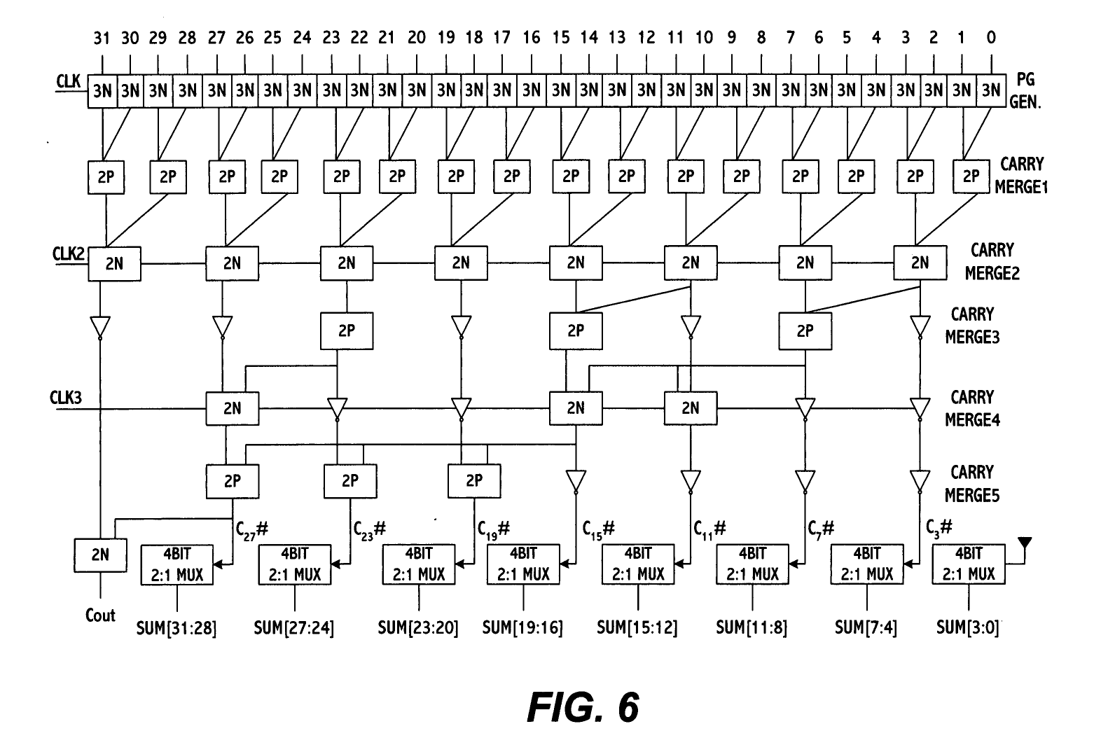

In embodiments of the present invention illustrated in FIGS. 6-8, both integer and floating point units in microprocessors may perform an ADD operation in a single clock cycle. Adders may be performance-critical units, setting the clock frequency of the processor. Further, the high power consumption associated with these units may result in power density issues and hotspots on the die. This purpose of embodiments of the invention is to improve upon the power performance of existing dual-rail domino implementations of high-performance adders. This may be achieved by a sparse-tree adder circuit that leverages the non-critical nature of sidepaths to implement them in static CMOS logic. The low switching activity on these static paths may result in considerable savings in average power consumption, without affecting the delay of the adder. Advantages of embodiments of the present invention may include 30% reduction in average power consumption with no delay penalty and/or 50% reduction in active leakage power.

FIG. 6 is an exemplary illustration of a sparse-tree adder circuit that includes a main tree that may generate primary carries and parallel side-paths that generate conditional-sums. The main-tree forms the performance-setting critical path of the adder and may be implemented in dynamic logic. As opposed to a conventional Kogge-Stone carry-look ahead tree, this tree does not generate the carries for every bit of the adder. Alternatively, in embodiments, this tree may generates 1 in 4 carries. In embodiments, this tree may generate 1 in 16 or 1 in 8 carries. Consequently, in embodiments, gates in a critical path may have 50% reduced fanouts on the group generate signals and 33% lower fanout on the group propagate signals.

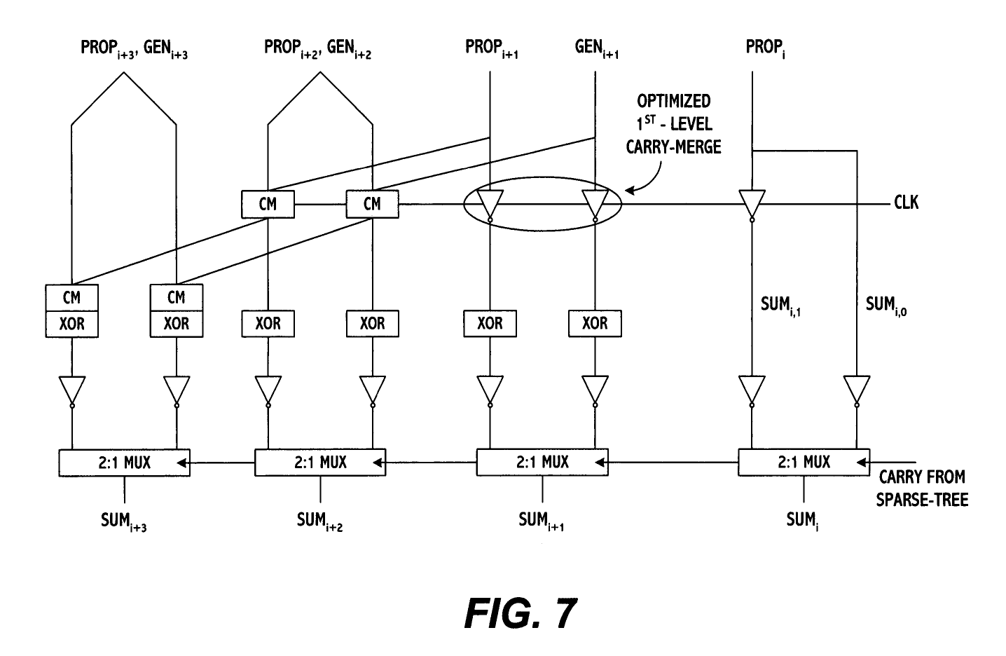

FIG. 7 illustrates exemplary parallel sidepaths that compute 4-bit conditional sums, assuming that the primary carry is a 0 and 1. When a main tree has completed evaluation, the primary carry may select the appropriate conditional sum to deliver the final sum. The sidepath in the sparse-tree adder may be non-critical and therefore may be implemented using static CMOS logic. To prevent the static sidepaths from pre-charging and evaluating every cycle in response to the clock signal, the first stage of the static paths may be converted to a Set-Dominant latch. This latch may hold it's previous state when the preceding domino stage goes into pre-charge. This may reduce the switching activity of the static sections to approximately 10%, which may result in a 30% reduction in average switching power.

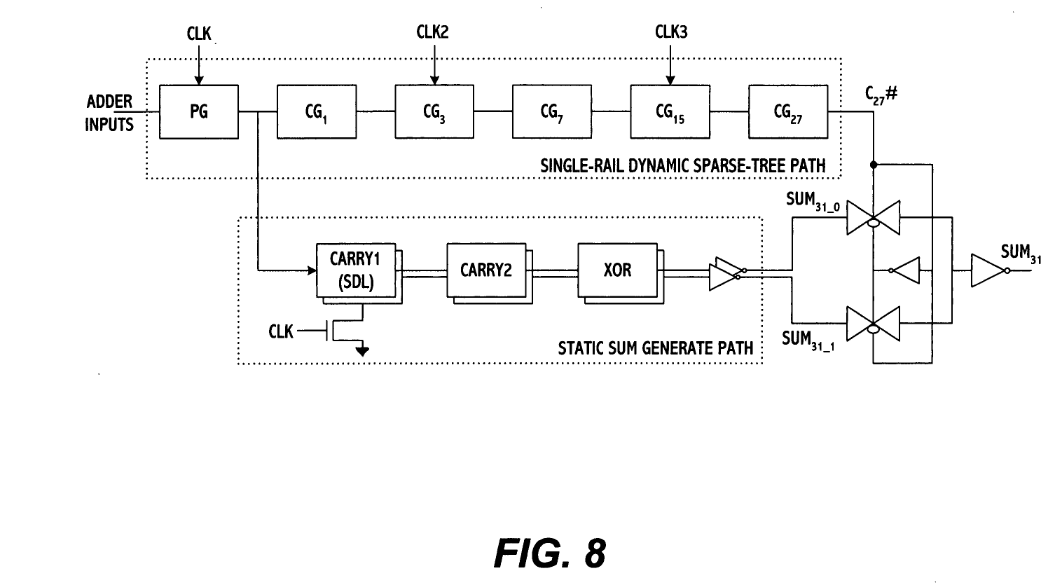

FIG. 8 is an exemplary illustration of static signals of sidepaths that meet domino signals of a main tree in the 2:1 multiplexer at stage 7 of an adder. This arrangement may contribute to avoidance of false evaluations that may occur at a static-domino interface. This interface may be time-borrowable and may avoid necessity a hard-clock boundary. A 2:1 multiplexer may be implemented using transmission gates. A 2:1 domino multiplexer may also be used if domino-compatible dual-rail primary carries are available. A dual-rail implementation may have the advantage of having monotonic sum outputs. In the semi-dynamic implementation shown in FIG. 6, the output sum can transition in either direction.

The non-critical paths may also be implemented using high-Vt transistors, while the critical main tree may be implemented with low-Vt devices. This dual-Vt allocation may reduce active leakage power by 50% without affecting adder performance. Embodiments of the present invention enable a high-performance dynamic adder circuit which has an average-energy profile that is similar to a static circuit. Further, 30% reduction in average switching energy and 50% reduction in active leakage energy may be obtained, thereby reducing the power density.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art.

What is claimed is:

1. An apparatus comprising:
a first data input coupled to:
a second data input of a first circuit, wherein the first circuit comprises dynamic logic, and
a third data input of a second circuit, wherein the second circuit comprises static logic; and
a third circuit comprising:
a fourth data input coupled to a first data output of the first circuit, and
a fifth data input coupled to a second data output of the second circuit.

2. The apparatus of claim 1, wherein the apparatus is comprised in an adder.

3. The apparatus of claim 2, wherein the adder is comprised in an arithmetic logic unit.

4. The apparatus of claim 3, wherein the arithmetic logic unit is comprised in a central processing unit.

5. The apparatus of claim 1, wherein the first circuit and the second circuit are configured to process the same data in parallel.

6. The apparatus of claim 1, wherein:
the first circuit is configured to perform performance critical operations; and
the second circuit is configured to perform non-performance critical operations.

7. The apparatus of claim 1, wherein:
the third circuit comprises a third data output that is a logical function of the fourth data input and the fifth data input.

8. The apparatus of claim 1, wherein the third circuit comprises circuitry that interfaces static logic and dynamic logic.

9. The apparatus of claim 1, wherein dynamic logic is circuitry configured such that each operation of the dynamic logic is independent from a previous or subsequent operation of the dynamic logic.

10. The apparatus of claim 9, wherein each operation of the dynamic logic utilizes a clock signal to pre-charge the dynamic logic.

11. The apparatus of claim 10, wherein the clock signal pre-charges the dynamic logic to reset the dynamic logic.

12. The apparatus of claim 1, wherein static logic is circuitry configured such that each operation of the static logic may operate according to the previous operation of the static logic.

13. The apparatus of claim 1, wherein:
the third data input of the second circuit is configured to receive a first number and a second number;
the second data output of the second circuit is configured to output a first set of sums and a second set of sums, wherein:
each sum of the first set of sums is the sum of a segment of the first number, an associated segment of the second number, and a carry; and
each sum of the second set of sums is the sum of a segment of the first number and an associated segment of the second number.

14. The apparatus of claim 13, wherein:
the second data input of the first circuit is configured to receive a first number and a second number; and
the first data output of the first circuit is configured to output an indication of whether the sum of a segment of the first number and an associated segment of the second number includes a sum of a carry.

15. The apparatus of claim 14, wherein:
the third circuit outputs the sum of a segment of the first number, an associated segment of the second number, and a carry if the first circuit outputs an indication that the sum of the segment of the first number and the associated segment of the second number includes a sum of the carry; and
the third circuit outputs the sum of a segment of the first number and an associated segment of the second number, if the first circuit outputs an indication that the sum of the segment of the first number and the associated segment of the second number does not include a sum of a carry.

16. The apparatus of claim 13, wherein at least one of the first number and the second number is a binary number.

17. The apparatus of claim 13, wherein the second circuit comprises a first set of adders and a second set of adders, wherein:
each adder of the first set of adders is configured to compute a sum of the first set of sums; and
each adder of the second set of adders is configured to compute a sum of the second set of sums.

18. The apparatus of claim 17, wherein each adder of the first set of adders operates in parallel.

19. The apparatus of claim 17, wherein each adder of the second set of adders operates in parallel.

20. The apparatus of claim 17, wherein adders of the first set of adders operate independently.

21. The apparatus of claim 17, wherein adders of the second set of adders operate independently.

22. A method comprising:
processing data in a first circuit and a second circuit in parallel, wherein:
the first circuit comprises dynamic logic; and
the second circuit comprises static logic.

23. The method of claim 22, comprising interfacing an output of the first circuit with an output of the second circuit.

24. The method of claim 22, wherein the processing data in the first circuit and the second circuit in parallel comprises:
performing performance-critical operations in the first circuit; and
performing performance-non-critical operations in the second circuit.

25. The method of claim 22, wherein dynamic logic is circuitry configured such that each operation of the dynamic logic is independent from a previous or subsequent operation of the dynamic logic.

26. The method of claim 22, wherein dynamic logic utilizes a clock signal that pre-charges the dynamic logic.

27. The method of claim 23, wherein the clock signal pre-charges the dynamic logic to reset the dynamic logic.

28. The method of claim 22, wherein static logic is circuitry configured such that each operation of the static logic operates according to a previous operation of the static logic.

29. A system comprising:
a die comprising a processor; and
an off-die component in communication with the processor;
wherein the processor comprises:
a first data input coupled to:
a second data input of a first circuit, wherein the first circuit comprises dynamic logic, and
a third data input of a second circuit, wherein the second circuit comprises static logic; and
a third circuit comprising:
a fourth data input coupled to a first data output of the first circuit, and
a fifth data input coupled to a second data output of the second circuit.

30. The system of claim 29, wherein the off-die component is at least one of a cache memory, a chip set, and a graphical interface.
